(19) United States
(12) Patent Application Publication
(10) Pub. No.: US 2012/0318463 A1
(43) Pub. Date: Dec. 20, 2012

(54) SEPARATION OF LAMINATED SHEETS

(75) Inventor: Anthony Anderson, Somerville (AU)

(73) Assignee: DELAM HOLDINGS PARTY LTD, Mount Waverley (AU)

(21) Appl. No.: 13/582,383

(22) PCT Filed: Mar. 1, 2011
(86) PCT No.: PCT/AU2011/000223

§ 371 Date: Aug. 31, 2012

(30) Foreign Application Priority Data
Mar. 1, 2010 (AU) 2010900860

(51) Int. Cl. B32B 38/10

(52) U.S. Cl. 156/712; 156/711; 156/752; 156/753

(57) ABSTRACT

There is disclosed a method of separating laminated sheets comprising first and second sheets which are bonded by an adhesive interlayer, the method comprising heating the interlayer to soften it and causing the first and second sheets to be forced apart when the interlayer is softened.

The present invention relates to separation of laminated sheets. The invention has particular, though not exclusive, application to laminated glass.

Laminated materials, particularly laminated glass materials, have various applications as construction material. They can, for example, be used to form windows, walls, doors, partitions, screens and vehicle windscreens and rear windows. They can also be used for the construction of articles such as coffee tables, and other small articles of furniture. Laminated materials can be particularly appropriate or preferred in a number of applications because of inherent safety characteristics they can offer over normal glass sheets.

Laminated materials are typically formed by joining two sheets of material using an adhesive interlayer, which commonly comprises polyvinyl butyral or a polyether-based aliphatic thermoplastic polyurethane.

Whilst laminated sheets are often made from material which is recyclable per se, there is often no satisfactory way of separating them from each other, and, more importantly, the adhesive interlayer(s) bonding them. As a result, laminated materials are discarded in very large amounts each year, not only creating wastage but also harm to the environment, particularly as a result of toxic chemicals which form the interlayer leaching into the earth and natural waterways.

According to a first aspect of the invention, there is provided a method of separating laminated sheets comprising first and second sheets which are bonded by an adhesive interlayer, the method comprising heating the interlayer to soften it and causing the first and second sheets to be forced apart when the interlayer is softened.

In a preferred embodiment of the invention, causing the first and second sheets to be forced apart comprises effecting movement of one of the first and second sheets relative to the other along a plane defined by the interlayer, thereby causing shearing in the interlayer.

In a preferred embodiment of the invention, causing the first and second sheets to be forced apart comprises effecting movement of one of the first and second sheets relative to the other in a direction transverse to a plane defined by the interlayer.

Preferably, causing the first and second sheets to be forced apart comprises effecting movement of one of the first and second sheets relative to the other both along and transverse to said plane. Preferably, the method includes effecting movement along said plane which movement is simultaneous with the movement transverse to said plane. Preferably, the movement along the plane is initiated before the movement transverse to the plane.

It will be appreciated that the laminate may comprise more than two sheets and thus a plurality of adhesive interlayers, so that either or both of the first and second sheets may be bonded to a (respective) further sheet. The invention is applicable, for example, to tri-laminates and quad-laminates.

Preferably, the method includes applying loads through opposed outer surfaces of the laminate to draw the first and second sheets apart. Preferably, the loads are applied by way of suction. Preferably, when the suction is discontinued, the sheets may be readily removed for recycling.

The suction may be applied by way of at least one suction cup or cap which engages a sheet outer face. Alternatively or additionally, the suction may be applied through at least one surface which engages a sheet outer face and is configured with openings therethrough through which openings air is drawn to create a vacuum which effects adherence of the outer face of the sheet to the surface.

Preferably, the method comprises applying radiation through at least one sheet of the laminate to effect heating of the adhesive interlayer. Advantageously, the radiation may be output at a frequency at which it is generally transmittable through the sheet material and generally absorbable by the interlayer. In this way, the heating applied to the laminate may be selective, whereby the sheet material is not heated appreciably or excessively. Preferably, the radiation comprises infrared radiation.

According to a second aspect of the invention, there is provided a method of separating an adhesive from first and second sheets, the adhesive forming an interlayer between the sheets to laminate them, the method comprising:
separating the first and second sheets via a method as described above; and
removing the adhesive from previously bonded surfaces of the sheets.

Preferably, the adhesive is removed when softened. In a preferred embodiment of the invention, the adhesive is mechanically removed. Advantageously, the adhesive as removed may be substantially uncontaminated and able to be recycled. The mechanical removal may comprise scraping and/or wiping the adhesive from said surfaces. The mechanical removal may alternatively or additionally comprise sucking the adhesive from the surface. The removal of the adhesive may additionally or alternatively comprise chemical removal.

According to a third aspect of the invention, there is provided an apparatus for separating laminated sheets comprising first and second sheets which are bonded by an adhesive interlayer, the apparatus comprising:
means for heating the interlayer to soften it; and
means for separating the first and second sheets (“the separating means”), the separating means being arranged to effect forcing apart of the first and second sheets when the interlayer is softened.

Preferably, the means for heating the interlayer comprises a radiation heat source. Preferably, the radiation heat source comprises an infrared heat source. Preferably, the radiation heat source is adjustable whereby the radiation may be output at a frequency at which it is generally transmittable through the sheet material and generally absorbable by the interlayer.

Preferably, the separating means is arranged remote from the heat source and the apparatus further comprises means for conveying the laminate from the heat source to the separating means.

Preferably, the separating means is configured to effect movement of one of the first and second sheets relative to the other along a plane defined by the interlayer, thereby causing shearing in the interlayer.

Preferably, the separating means is configured to effect movement of one of the first and second sheets relative to the other in a direction transverse to a plane defined by the interlayer.

More preferably, the separating means is configured to effect movement of one of the first and second sheets relative to the other both along and transverse to said plane. Preferably, the separating means is configured to effect the movement along said plane such that it is simultaneous with the movement transverse to said plane. Preferably, the separating means is configured to initiate the movement along the plane before initiating the movement transverse to the plane.

Preferably, the separating means is configured to apply loads through opposed outer surfaces of the laminate to draw the first and second sheets apart. Preferably, the separating means is configured to apply the loads by way of suction.

Preferably, the separating means comprises at least one pulling member engageable with at least one of the outer surfaces and operable to effect pulling of one of the first and second sheets away from the other.

In a preferred embodiment of the invention, the or each pulling member comprises a suction cup or cap arranged to engage the respective surface. In an alternative embodiment, the or each pulling member comprises a surface which is engageable with a said outer surface and through which openings are formed, and the separating means further comprises means, such as a vacuum pump, to draw air through the openings to create a vacuum which draws the outer face against the pulling member; in one embodiment, the pulling member comprises a plate configured for abutment (direct or indirect) with the outer face, through which plate the openings are formed/air is drawn. The apparatus according to a further alternative embodiment comprises a plurality of said pulling members, comprising a combination consisting of at least one said suction cap/cup and the surface with openings therethrough, and the means to draw air through the openings.

In one embodiment of the invention, the apparatus comprises a vacuum bed arranged to engage one of the sheets and means, engageable with the other sheet, to draw the other sheet away from said one sheet. Preferably, the means to draw the other sheet away from the one sheet comprises at least one said pulling member. Preferably, the vacuum bed is arranged to support a lowermost one of the first and second sheets. The vacuum bed may be provided with a soft covering so as to reduce/eliminate a risk of damage to the sheet it engages.

In a preferred embodiment of the invention, the interlayer comprises polyvinyl butyral (PVB). The interlayer may alternatively or additionally comprise one or more of: urethane, polyvinyl acetate (PVA), polyester (PET), ionoplast resin (ionomer); polyurethanes (PU), polyvinyl chlorides, polycarbonate; polyacetal, ethylene acid copolymers, including ethylene acid terpolymers (acid copolymers), ethylene-vinyl acetate (EVA) and polyolefin, including polyethylenes and polypropylenes.

It has been found that, for several embodiments, including in particular embodiments in which the adhesive comprises PVB and ionoplasts, it is satisfactory to heat the interlayer to a temperature of between about 110° C. and about 150° C., and that a temperature of about 130° C. is optimal.

In a preferred embodiment of the invention, the sheets are formed from laminating glass. Alternatively or additionally, the sheets may be formed from an acrylic, plastics and/or thermoplastics.

The present invention will now be described, by way of non-limiting example only, with reference to the accompanying schematic drawings, in which:

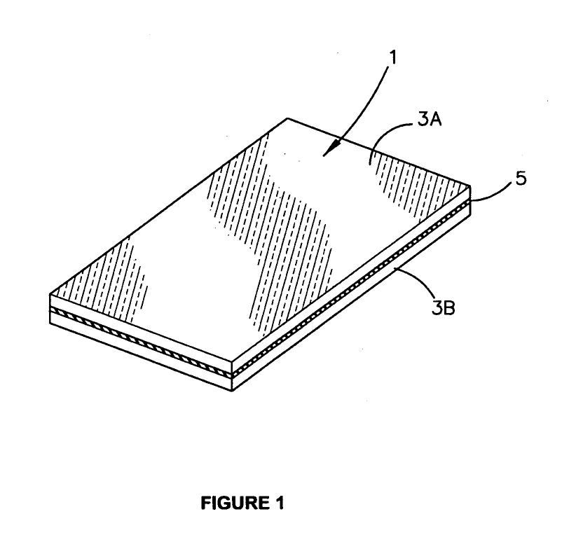

FIG. 1 is a view of a laminate in which two sheets are bonded together by an adhesive interlayer;

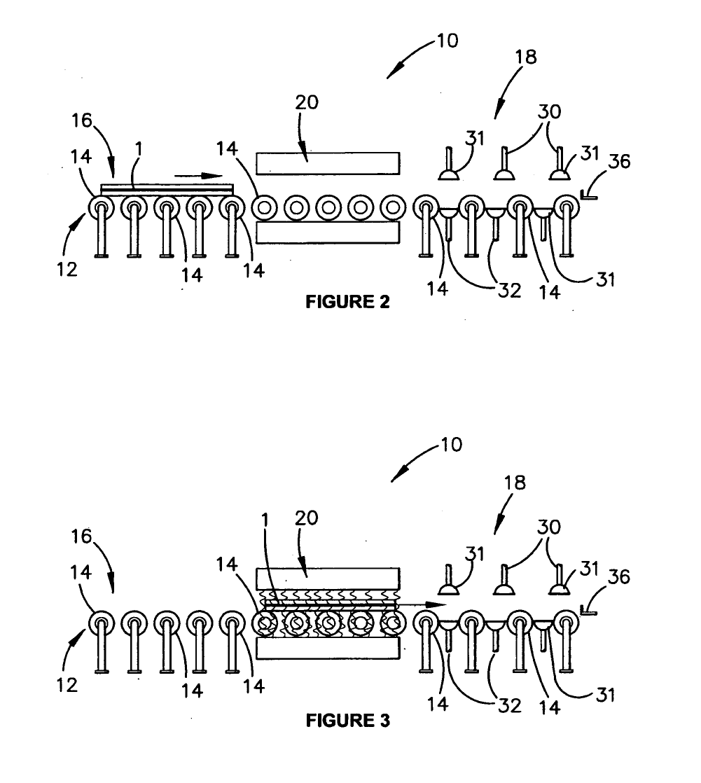

FIGS. 2 to 4 are side views of the laminate in successive stages of a delamination process in a delaminating apparatus according to a preferred embodiment of the present invention;

FIGS. 5 to 7 are views of further successive stages of the process, in which sheets of the laminate are being separated;

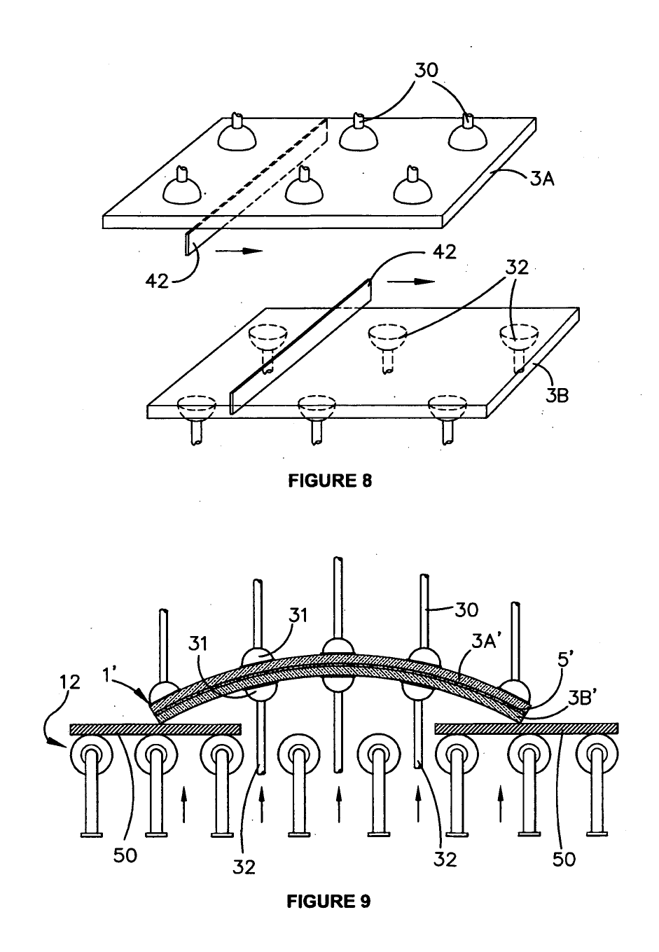

FIG. 8 is a view showing collection of adhesive from the previously bonded surfaces of the thus separated sheets;

FIG. 9 is a view showing use of the apparatus to separate a laminate comprising curved sheets; and

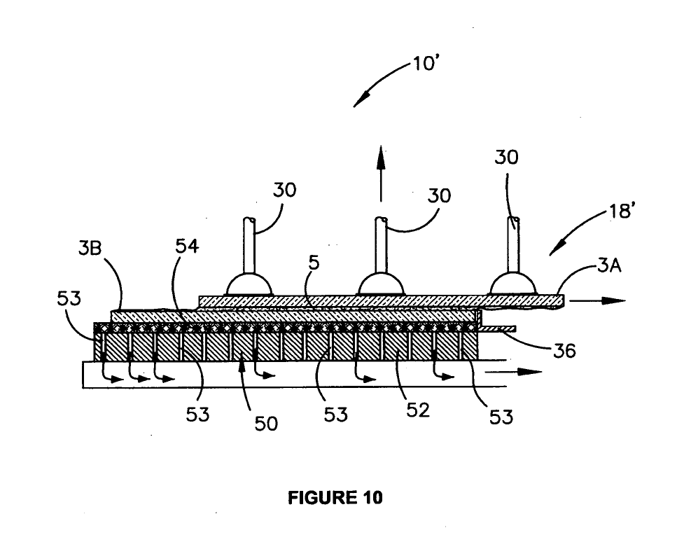

FIG. 10 is a view showing separation of laminated sheets using an apparatus in accordance with an alternative preferred embodiment of the invention.

A laminate 1 to be subjected to a delamination process in a delaminating apparatus in accordance with a preferred embodiment of the present invention is illustrated in FIG. 1. The laminate 1 comprises two glass sheets 3A, 3B (referred to collectively with numeral “3”) and an adhesive interlayer 5 bonding the sheets 3 together. In the present embodiment, the adhesive is polyvinyl butyral (PVB).

While the sheets in the embodiment are glass, it will be appreciated that each may be formed from an alternative material, such as, for example, polycarbonate, acrylic, cellulose acetate butyrate (CAB) or other thermoplastic resins.

Moreover, in other embodiments, the laminate may comprise an interlayer formed of a different material, such as, for example, urethane, polyurethane, ethyl vinyl acetate (EVA) or an ionoplast (such as that marketed by DuPont under the trade mark SentryGlas).

A delamination apparatus 10 for separating the sheets 3 is shown in FIGS. 2 to 4. The apparatus 10 comprises a conveyor 12 which is formed by a series of rollers 14.

In the present embodiment, the rollers are unpowered and the conveyor is thus passive, though in other embodiments, the conveyor may be powered. The conveyor, moreover, may, in other embodiments, take any of a variety of forms, such as, for example, that of a belt conveyor.

The apparatus 10 has a loading area 16, at an upstream end of the conveyor 12, where the laminate 1 can be laid onto the rollers 14 at that end, and a separator 18 arranged at a downstream end of conveyor 12, which will be described in further detail later.

The apparatus further comprises a heater 20 disposed between the upstream and downstream ends, through which conveyor 12 passes, the heater 20 comprising an infrared (IR) oven. The heater 20 has a selectably variable output, whereby the frequency of the infrared radiation it emits can be set such that the radiation is transmittable through the sheet material but absorbed by the interlayer material. The heater 20 may thus be used for “selective heating” of the interlayer 5 within the laminate 1.

In other embodiments, the heater may be, for example, a convective heater, and may be gas-fired or electrical.

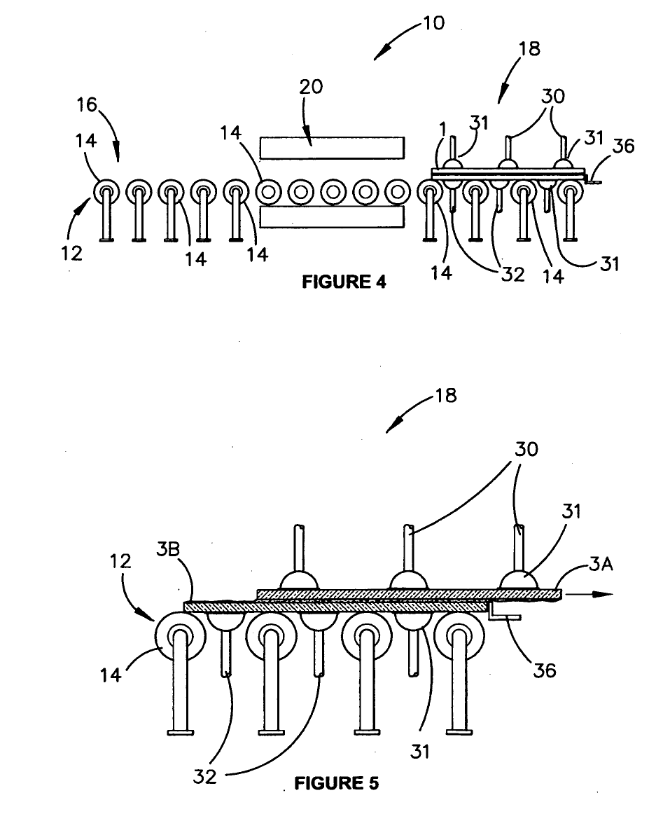

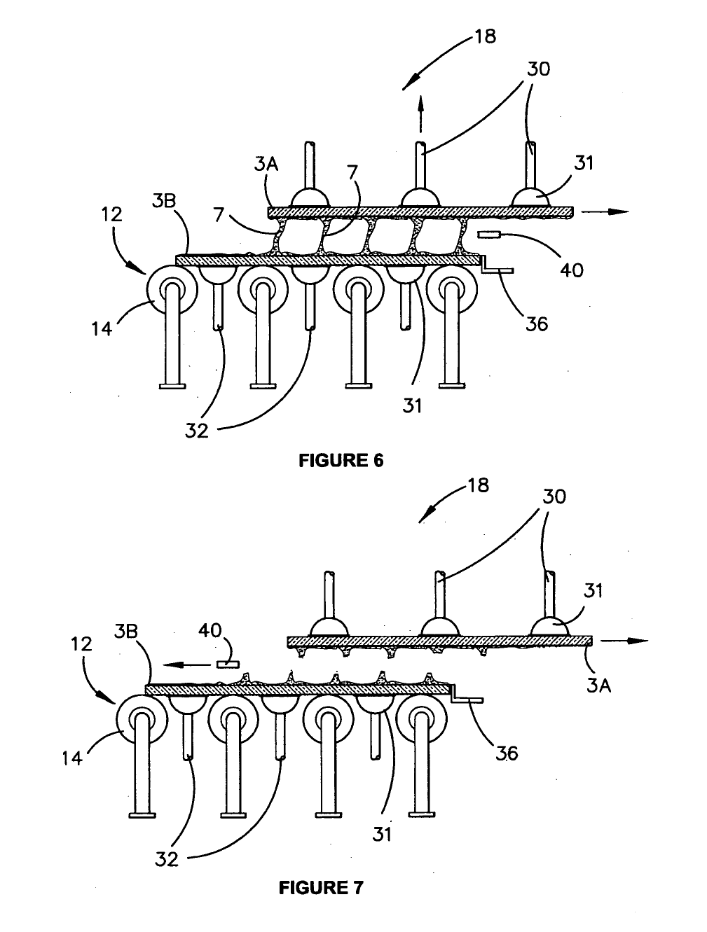

The separator 18, which is downstream of the heater 20, includes upper 30 and lower 32 pulling members, each incorporating a suction cup 31 capable of withstanding temperatures of up to 200° C., such as silicone suction cups. The upper 30 and lower 32 members, which are shown in a retracted condition in FIG. 2, are arranged in respective arrays (as can be seen in FIG. 8) so as to be engageable with the upper and lower sheets 3 in a regularly distributed manner over the sheet areas. The members 30, 32 in both arrays are moveable between the retracted positions shown in FIG. 2 and extended positions, which can be seen in FIG. 4. Upper members 30 are also moveable laterally, as shown in FIGS. 5 and 6 and as will be described in further detail later. The members may be actuated via any suitable means, e.g. hydraulically or pneumatically.

The separator 18 further comprises a retainer or stopper 36 arranged to abut the leading edge of lower sheet 3B when the laminate 1 is received by the separator 18, the function of which will be described later.

A method of separating the sheets 3 using the apparatus 10 will now be described.

Firstly, with reference to FIG. 2, the laminate 1 is lowered onto the rollers 14 at the upstream end 16. Referring to FIG. 3, the laminate 1 is then moved forwardly along the conveyor rollers 14, into heater 20, where it is subjected to infrared heating until interlayer 5 is sufficiently soft to enable the sheets 3 to be drawn apart by the separator 18. For both PVB and an ionoplast such as SentryGlas ionoplast, it has been determined that an interlayer temperature of between about 110° C. and about 150° C. is generally suitable, and that a temperature of about 130° C. is optimal.

Once the interlayer 5 is at the desired temperature, the laminate 1 is drawn along the conveyor from the heater 20 to the separator 18.

Once the laminate 1 is received at the downstream end of the conveyor 12, whereby lower sheet 3B leading edge abuts stopper 36, the upper and lower pulling members 30, 32 are moved into their extended positions such ‘that their suction cups 31 engage the opposed surfaces of the laminate 1, as shown in FIG. 4. The upper members 30 are then driven forwardly, imparting a forward force into the laminate 1, as depicted in FIG. 5. Because the lower members 32 are stationary and lower sheet 3B abuts stopper 36, only the upper sheet 3A can move forwardly with the upper suction members 30, so that a shearing force is created in the laminate 1 between the upper and lower sheets 3. When the shearing force has become sufficient to overcome the resistance offered by the interlayer material, the upper sheet 3 begins to move over the lower sheet 3, and the members 30 are retracted to pull the upper sheet 3 away from the lower sheet 3, whereby the sheets 3 are drawn apart (see FIG. 6). Advantageously, it has been found that effecting simultaneous movement of one sheet relative to the other along the plane defined by the interlayer and movement of one plate relative to the other transverse to that plane enhances separation. In particular, the in-plane movement results in breaking and tearing of adhesive and reduces van der Waals forces between the sheets being separated whereby the sheets are significantly easier then to draw apart than they would be in the absence of the in-plane movement (in which case a “suction effect” in the adhesive would contribute to the sheets’ resistance to being drawn apart). Preferably, the in-plane movement is initiated before the transverse movement.

The separator 18 may comprise a stopper (not shown) which is fixed with respect to the upper members 30 in the direction of lateral movement thereof, engageable with the trailing edge of the upper sheet 3A, to assist in transferring the lateral separating force into that sheet, or respective such retainers/stoppers could be provided to engage opposed edges of both sheets (which could be side edges rather than leading/trailing edges). If the engagement between the pulling members and sheets creates sufficient friction, no stopper will be necessary.

If necessary, a blade 40 can then be advanced between the sheets 3 after they are forced apart to sever strings 7 of adhesive extending between the inner faces of the sheets 3.

Next, as shown in FIG. 8, whilst the sheets 3 remain supported by the members 30, 32 and the adhesive remains hot and therefore sufficiently soft, the inner surface of each sheet 3 is scraped with a wiper blade 42 to remove the adhesive therefrom for placement into a collection receptacle. Advantageously, both the sheets 3 and the adhesive can then be recycled.

It will be appreciated that the invention is applicable in principle to laminated sheets in any of a wide variety of sizes and shapes. In particular, the method and apparatus are applicable to laminates which are not flat—for example windscreens and vehicle rear windows. To this end, the angular orientation of the suction cups 31 of the upper 30 and lower 32 members is adjustable, whereby those members can engage a laminate 1′ comprising upper and lower sheets 3A′ and 3B′ and an interlayer 5′ which lie in a curved plane. If appropriate, the alternatively shaped laminate may be supported at the appropriate position(s) via a respective support panel 50 or the like whereby it may be supported on and conveyed by the conveyor 12.

An apparatus 10′ for separating laminating sheets in accordance with a second preferred embodiment of the invention is illustrated in FIG. 10. The apparatus 10′ is identical to the apparatus 10, though separator 18′ comprises, for supporting the lower sheet 3, a bed 50, instead of sucker members and rollers. The bed 50 comprises a lower table 52, in the form of a flat panel, and a soft covering 54 applied over the table 52. The table 52 is configured with a plurality of suction apertures 53 therethrough, which are distributed over its area, and the separator 18′ is configured with appropriate suction means, typically a pump, to draw air through the apertures 53. The covering 54, to permit intake of air into the apertures 53, is air-permeable, and in the present embodiment is formed from felt or a similar material. When air is drawn through the apertures 53, a vacuum is created at the surface of the covering 54 on which the lower sheet 3 rests, whereby that sheet is drawn against the bed 50 and the sheet 3 can be drawn apart in the manner already described.

It will be appreciated, that in other embodiments, the covering may be formed from other suitable air-permeable materials, particularly porous materials. The apertured support panel which forms the table may, in other embodiments be uncovered, and/or made of a sufficiently soft material to eliminate the risk of damage to, particularly scratching of chipping, of the sheets (if appropriate).

In other embodiments, the separator may be configured with combination comprising at least one sucker member, e.g. of the type already described and illustrated, and at least one bed to engage the lower sheet.

In another alternative embodiment, the separator may comprise an advanceable/retractable suction/vacuum bed that engages the top sheet 3, which may be similar to bed 52 (though would, of course, be inverted). Such a bed could be provided in combination with at least one sucker member, to operate in conjunction therewith, or be provided instead of sucker members.

In the embodiments in which one or more suction beds are provided, or each bed may have a sheet-engaging surface profiled complementarily to the profile of the sheet it engages; for example, the sheet-engaging surface(s) may be curved. Alternatively or additionally, or the or each bed may be angular and translationally orientatable to engage sheet surfaces of varying profile.

In another embodiment in which one sheet is above the other during separation, it may be that the separator need not be configured to exert a downward load/reaction force on the lower sheet if the lower sheet is sufficiently heavy.

In other embodiments, the separator need not comprise pulling members which engage the sheets by suction. In alternative embodiments, pulling members may be provided which, for example, are configured for threaded engagement with threaded holes formed into the sheets. In other alternative embodiments, the separator may instead comprise opposed surfaces having formed therethrough apertures through which air is drawn to create a vacuum and thus a suction engagement between those surfaces and the outer sheets of the laminate.

It will, of course, be appreciated that the method and apparatus according to the invention are applicable to laminates comprising three or more sheets bonded by interlayers, and that the separating step may be repeated to separate either or each of the separated sheets from an additional sheet bonded to its other side. The or each further separation step may be carried out immediately after the initial separation step or after a respective subsequent heating step.

Also, embodiments are possible in which the sheets need not be arranged one above the other for separation.

Many modifications will be apparent to those skilled in the art without departing from the scope of the present invention.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of separating laminated sheets comprising first and second sheets which are bonded by an adhesive interlayer, the method comprising heating the interlayer to soften it and causing the first and second sheets to be forced apart when the interlayer is softened.

2. A method according to claim 1, wherein causing the first and second sheets to be forced apart comprises effecting movement of one of the first and second sheets relative to the other along a plane defined by the interlayer, thereby causing shearing in the interlayer.

3. A method according to claim 1, wherein causing the first and second sheets to be forced apart comprises effecting movement of one of the first and second sheets relative to the other in a direction transverse to a plane defined by the interlayer.

4. A method according to claim 3, wherein causing the first and second sheets to be forced apart comprises effecting movement of one of the first and second sheets relative to the other along a plane defined by the interlayer, thereby causing shearing in the interlayer, and further comprising effecting movement along said plane simultaneous with the movement transverse to said plane.

5. A method according to claim 34, wherein causing the first and second sheets to be forced apart comprises effecting movement of one of the first and second sheets relative to the other along a plane defined by the interlayer, thereby causing shearing in the interlayer, and wherein the movement along the plane is initiated before the movement transverse to the plane.

6. A method according to claim 1, comprising applying loads through opposed outer surfaces of the laminate to draw the first and second sheets apart.

7. A method according to claim 1, comprising applying radiation through at least one sheet of the laminate to effect heating of the adhesive interlayer.

8. A method according to claim 7, comprising outputting the radiation at a frequency at which it is generally transmittable through the sheet material and generally absorbable by the interlayer.

9. A method according to claim 1, further comprising:
removing the adhesive from the previously bonded sheets.

10. A method according to claim 9, wherein the adhesive is removed when softened.

11. An apparatus for separating laminated sheets comprising first and second sheets which are bonded by an adhesive interlayer, the apparatus comprising:
means for heating the interlayer to soften it; and
means for separating the first and second sheets (“the separating means”), the separating means being arranged to effect forcing apart of the first and second sheets when the interlayer is softened.

12. An apparatus according to claim 11, wherein the means for heating the interlayer comprises a radiation heat source.

13. An apparatus according to claim 12, wherein the radiation heat source is adjustable whereby the radiation may be output at a frequency at which it is generally transmittable through the sheet material and generally absorbable by the interlayer.

14. An apparatus according to claim 12, wherein the radiation heat source comprises an infrared radiation heat source.

15. An apparatus according to claim 11, wherein the separating means is arranged remote from the heat source and the apparatus further comprises means for conveying the laminate from the heat source to the separating means.
